(19) United States
(12) Patent Application Publication
(10) Pub. No.: US 2026/0118571 A1
(43) Pub. Date: Apr. 30, 2026

(54) Segmented Hybrid Optical Waveguide

(71) Applicant: Sunny Omnilight Technology Co., Ltd., Yuyao (CN)

(72) Inventors: Zhiming CHENG, Yuyao (CN); Cong WANG, Yuyao (CN); Wei ZHANG, Yuyao (CN); Jian LOU, Yuyao (CN); Yusheng MING, Yuyao (CN); Jie WANG, Yuyao (CN); Yuan CHEN, Yuyao (CN)

(73) Assignee: Sunny Omnilight Technology Co., Ltd., Yuyao (CN)

(21) Appl. No.: 18/990,097

(22) Filed: Dec. 20, 2024

(30) Foreign Application Priority Data
Oct. 24, 2024 (CN) 202422596834.5

(51) Int. Cl. F21V 8/00

(52) U.S. Cl. CPC G02B 6/0016; G02B 6/0036

(57) ABSTRACT

The disclosure provides a segmented hybrid optical waveguide. The segmented hybrid optical waveguide includes a first portion and a second portion; where the first portion includes a first-layer structure and a second-layer structure that are stacked in a first direction, the second-layer structure is provided with a coupling-in region and a turning region, and the coupling-in region is configured to couple light in; and the second portion is spliced to the first portion in a second direction, the second direction is provided perpendicular to the first direction, a thickness of the first portion in the first direction equals a thickness of the second portion in the first direction, and the second portion is provided with a coupling-out region. According to the disclosure, the problem of a big difference in thicknesses applicable to different structures of a hybrid optical waveguide in the related art is solved.

### CROSS-REFERENCE TO RELATED APPLICATION(S)

This application claims priority to Chinese Patent Application No. 202422596834.5 filed on Oct. 24, 2024, the entire contents of each of which are incorporated herein by reference for all purposes. No new matter has been introduced.

### FIELD

The disclosure relates to the technical field of optical waveguides, and in particular to a segmented hybrid optical waveguide.

### BACKGROUND

As a novel optical element combining advantages of an arrayed optical waveguide and a surface relief optical waveguide, a hybrid optical waveguide is attempting to provide an optical waveguide solution having high efficiency and low optical leakage, so as to improve production efficiency and process feasibility in the related art.

On the basis of diffraction characteristics of a grating, the surface relief optical waveguide realizes light deflection and color separation. However, when a thickness of a grating region is provided to be too large, a total reflection step size of light in the waveguide will be increased, leading to an increase in pupil expansion step, and eventual separation of a pupil in a propagation process. In consequence, light in different colors cannot be focused at pupils of human eyes simultaneously, resulting in color aliasing and degradation in visual clarity, and thus an optical effect and visual experience are affected.

The arrayed optical waveguide is favored for high efficiency, color consistency, and low light leakage, so as to be particularly suitable for display modules in applications of augmented reality (AR), virtual reality (VR), etc. However, when a light splitting layer of the arrayed optical waveguide is too thin, more light splitting layers are required, but with a too small distance between adjacent light splitting layers, light cannot complete sufficient total internal reflection steps before reaching a next light splitting layer. In consequence, the light cannot be effectively separated and guided in subsequent propagation, leading to an increase in process difficulty and cost, and a decrease in product yield.

In other words, there is a big difference in thicknesses applicable to different structures of the hybrid optical waveguide in the related art.

### SUMMARY

Some embodiments of the disclosure are to provide a segmented hybrid optical waveguide, so as to solve the problem of a big difference in thicknesses applicable to different structures of the hybrid optical waveguide in the related art.

An embodiment of the disclosure provides the segmented hybrid optical waveguide. The segmented hybrid optical waveguide includes a first portion, where the first portion includes a first-layer structure and a second-layer structure that are stacked in a first direction, the second-layer structure is provided with a coupling-in region and a turning region, and the coupling-in region is configured to couple light in; and a second portion, where the second portion is spliced to the first portion in a second direction, the second direction is provided perpendicular to the first direction, a thickness of the first portion in the first direction equals a thickness of the second portion in the first direction, and the second portion is provided with a coupling-out region.

In an embodiment mode, the second portion includes a plurality of light splitting layers stacked in a direction away from the first portion, the light splitting layers are provided with light splitting surfaces arranged obliquely with respect to the second direction, and the light splitting surfaces are configured to couple the light out.

In an embodiment mode, the first-layer structure is in molecular bonding connection to the second-layer structure; and a refractive index n_{base} of the second-layer structure, a refractive index n_{glass} of the first-layer structure, and a minimum incident angle αₘᵢₙ of the light in a direction from the second-layer structure to the first-layer structure satisfy n_{base}−n_{glass}≥n_{base}*(1−sin(αₘᵢₙ)).

In an embodiment mode, the first-layer structure is in bonding connection to the second-layer structure by means of a bonding glue; and the refractive index n_{base} of the second-layer structure, a refractive index n_{glue} of the bonding glue, and a minimum incident angle αₘᵢₙ of the light in a direction from the second-layer structure to the first-layer structure satisfy n_{base}−n_{glue}≥n_{base}*(1−sin(αₘᵢₙ)).

In an embodiment mode, a surface on one side, close to the first-layer structure, of the second-layer structure is provided with the coupling-in region, and a surface on one side, away from the first-layer structure, of the second-layer structure is provided with a plurality of turning grating regions, so as to form the turning region.

In an embodiment mode, a reflection surface is arranged on one side, away from the second portion, of the second-layer structure, and a refractive index of the second-layer structure is greater than that of the first-layer structure, so that the light is incident from a surface on one side, away from the second-layer structure, of the first-layer structure, reflected by the reflection surface through a coupling-in opening of the coupling-in region, and then transmitted in the second-layer structure in a total reflection mode; and an included angle θ₁ between the reflection surface and a surface on one side, in the first direction, of the second-layer structure satisfies 25°<θ₁<35°.

In an embodiment mode, the second portion includes a plurality of light splitting layers stacked in a direction away from the first portion, and the light splitting layers are provided with light splitting surfaces arranged obliquely with respect to the second direction; and an inclination angle β of the light splitting surfaces equals the included angle θ₁, and a thickness T of the second portion, the included angle θ₁, and a distance Δd between two adjacent light splitting surfaces satisfy 0.90*T/tan(θ₁)<Δd<1.10*T/tan(θ₁).

In an embodiment mode, one side, away from the second portion, of the second-layer structure is provided with the coupling-in region, and an included angle θ₂ between a surface where a coupling-in opening of the coupling-in region is located, and a surface on one side, in the first direction, of the second-layer structure satisfies 50°<θ₂<70°.

In an embodiment mode, a surface on one side, away from the first-layer structure, of the second-layer structure is provided with a plurality of turning grating regions, so as to form the turning region.

In an embodiment mode, the second portion includes a plurality of light splitting layers stacked in a direction away from the first portion, and the light splitting layers are provided with light splitting surfaces arranged obliquely with respect to the second direction; and an inclination angle β of the light splitting surfaces is half of the included angle θ₂, and a thickness T of the second portion, the included angle θ₂, and a distance Δd between two adjacent light splitting surfaces satisfy 0.90*T/tan(θ₂)<Δd<1.10*T/tan(θ₂).

In an embodiment mode, a surface on one side, away from the first-layer structure, of the second-layer structure is provided with the coupling-in region, and a plurality of turning grating regions to form the turning region; and a coupling-in opening of the coupling-in region is provided with a coupling-in grating, so that the light is coupled in the second-layer structure through the coupling-in grating.

In an embodiment mode, the plurality of turning grating regions include a first grating region 1 to an Nth grating region arranged in a direction close to the second portion, 3<N<8, and the first grating region 1 to the Nth grating region have an identical grating period and an identical grating line angle; and first-order diffraction efficiency of a second grating region to the Nth grating region is gradually increased, and the first-order diffraction efficiency eff satisfies 0.03<eff<0.77.

In an embodiment mode, the light splitting layers and the second-layer structure are made of a same material.

In an embodiment mode, reflective indexes of the light splitting surfaces are gradually increased in the direction away from the first portion, a minimum reflective index of all the light splitting surfaces satisfies 0.02<Rmin<0.14, and a maximum reflective index of all the light splitting surfaces satisfies 0.13<Rmax<0.35.

In an embodiment mode, a thickness t_{glass} of the first-layer structure satisfies 0.2 mm<t_{glass}<5.0 mm.

In an embodiment mode, a thickness t_{base} of the second-layer structure satisfies 0.2 mm<t_{base}<5.0 mm.

In an embodiment mode, a thickness T of the second portion satisfies 0.4 mm<T<10 mm.

In an embodiment mode, a refractive index n_{glass} of the first-layer structure satisfies 1.5<n_{glass}<2.2.

With the technical solution of the disclosure applied, the segmented hybrid optical waveguide includes the first portion and the second portion; where the first portion includes the first-layer structure and the second-layer structure that are stacked in the first direction, the second-layer structure is provided with the coupling-in region and the turning region, and the coupling-in region is configured to couple the light in; and the second portion is spliced to the first portion in the second direction, the second direction is provided perpendicular to the first direction, the thickness of the first portion in the first direction equals the thickness of the second portion in the first direction, and the second portion is provided with the coupling-out region.

The segmented hybrid optical waveguide of the disclosure is divided into two main components, where the first portion is spliced to the second portion in the second direction, the first portion guides the light to be transmitted to the second portion, and the second portion can couple the light out of the segmented hybrid optical waveguide in the first direction while guiding the light to be transmitted in the second direction. The light enters the second-layer structure from the coupling-in region, and a pupil is enlarged and an optical path is turned through the turning region in the second-layer structure. After the light enters the second portion, the coupling-out region couples the light out. By limiting the thickness of the first portion to be identical to the thickness of the second portion in the first direction, light loss may be reduced while machining and splicing of the first portion and the second portion are facilitated. In view of the above, since there is a big difference in thicknesses applicable to the second-layer structure and the second portion, the first-layer structure is stacked on the second-layer structure in the first direction, and uniformity of the thicknesses of the first portion and the second portion is realized. In addition to reduction in the light loss, the second-layer structure and the second portion can both have the ideal thicknesses adapted to their machinability and optical effects, so that more efficient coupling-in and coupling-out are realized. In addition, the design is conducive to appearance uniformity and function integration of the segmented hybrid optical waveguide, and the use in conjunction with other optical elements is facilitated accordingly.

### BRIEF DESCRIPTION OF DRAWINGS

The drawings of the description are used for providing further understanding of the disclosure as a constituent part of the disclosure. Illustrative examples of the disclosure and their descriptions serve to explain the disclosure, instead of limiting the disclosure improperly. In the accompanying drawings:

FIG. 1 is an external view of a segmented hybrid optical waveguide according to Example 1 of the disclosure;

FIG. 2 is a schematic diagram of a first portion and a second portion of the segmented hybrid optical waveguide in FIG. 1;

FIG. 3 is a sectional view of the segmented hybrid optical waveguide in FIG. 1;

FIG. 4 is an external view of a segmented hybrid optical waveguide according to Example 2 of the disclosure;

FIG. 5 is a schematic diagram of a first portion and a second portion of the segmented hybrid optical waveguide in FIG. 4;

FIG. 6 is a sectional view of the segmented hybrid optical waveguide in FIG. 4;

FIG. 7 is an external view of a segmented hybrid optical waveguide according to Example 3 of the disclosure;

FIG. 8 is a schematic diagram of a first portion and a second portion of the segmented hybrid optical waveguide in FIG. 7;

FIG. 9 is a sectional view of the segmented hybrid optical waveguide in FIG. 7; and

FIG. 10 is a parameter diagram of a segmented hybrid optical waveguide matching a light source according to any optional example of the disclosure.

The above accompanying drawings include the reference numerals as follows:

10. first portion; 11. first-layer structure; 12. second-layer structure; 13. coupling-in region; 14. coupling-in opening; 15. reflection surface; 16. turning region; 17. turning grating region; 171. first grating region; 18. coupling-in grating; 20. second portion; 21. coupling-out region; 22. light splitting layer; and 23. light splitting surface.

### DESCRIPTION OF EMBODIMENTS

It should be noted that examples of the disclosure and features in the examples may be mutually combined without conflicts. The disclosure will be described in detail below in conjunction with the accompanying drawings and the examples.

It should be pointed out that all the technical and scientific terms used in the disclosure have the same meanings as those commonly understood by those of ordinary skill in the art to which the disclosure pertains, unless defined otherwise.

In the disclosure, the orientation words used such as “upper, lower, top, and bottom” are generally based on the directions shown in the accompanying drawings, or the vertical, perpendicular, or gravitational directions of the components themselves, unless stated otherwise. Similarly, for ease of understanding and description, “interior and exterior” indicate the interior and exterior relative to the outline of each component itself, but the above orientation words are not used to limit the disclosure.

In order to solve the problem of a big difference in thicknesses applicable to different structures of the hybrid optical waveguide in the related art, the disclosure provides a segmented hybrid optical waveguide.

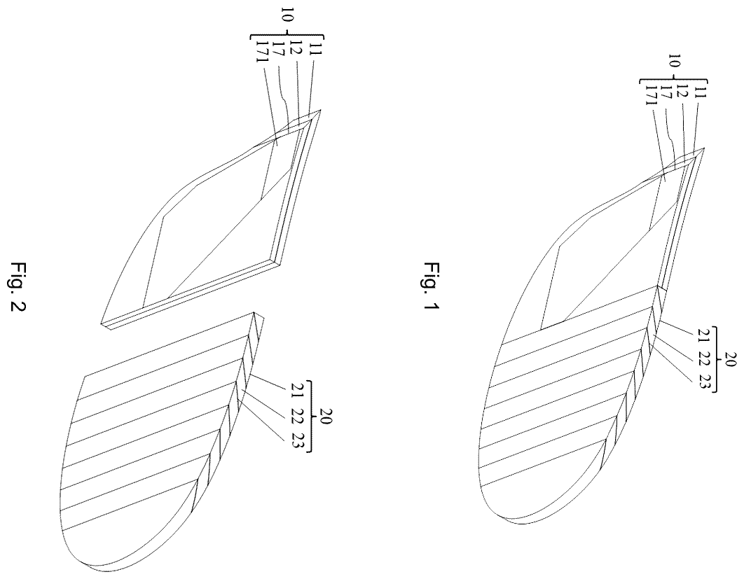

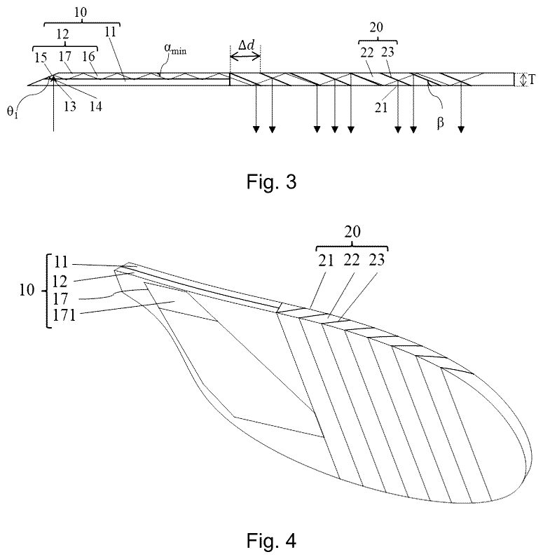

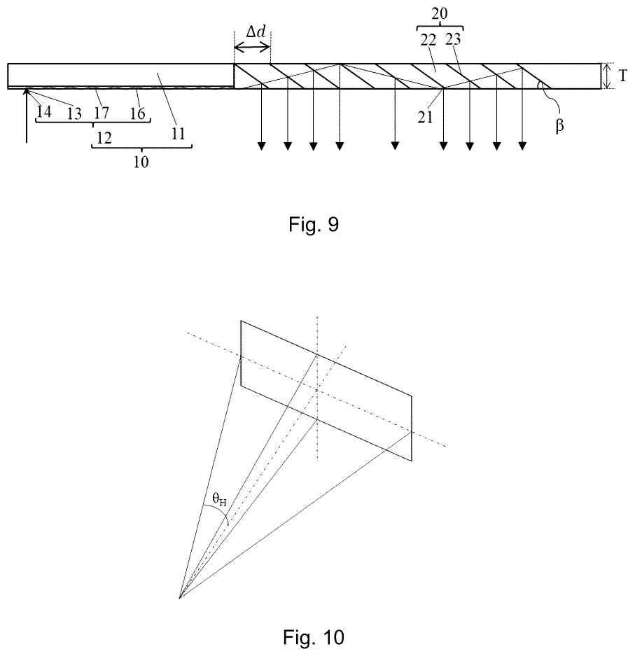

As shown in FIGS. 1-10, the segmented hybrid optical waveguide includes a first portion 10 and a second portion 20; where the first portion 10 includes a first-layer structure 11 and a second-layer structure 12 that are stacked in a first direction, the second-layer structure 12 is provided with a coupling-in region 13 and a turning region 16, and the coupling-in region 13 is configured to couple light in; and the second portion 20 is spliced to the first portion 10 in a second direction, the second direction is provided perpendicular to the first direction, a thickness of the first portion 10 in the first direction equals a thickness of the second portion 20 in the first direction, and the second portion 20 is provided with a coupling-out region 21.

The segmented hybrid optical waveguide of the disclosure is divided into two primarily components, where the first portion 10 is spliced to the second portion 20 in the second direction, the first portion 10 guides the light to be transmitted to the second portion 20, and the second portion 20 can couple the light out of the segmented hybrid optical waveguide in the first direction while guiding the light to be transmitted in the second direction. The light enters the second-layer structure 12 from the coupling-in region 13, and a pupil is enlarged and an optical path is turned through the turning region 16 in the second-layer structure 12. After the light enters the second portion 20, the coupling-out region 21 couples the light out. By limiting the thickness of the first portion 10 to be identical to the thickness of the second portion 20 in the first direction, light loss may be reduced while machining and splicing of the first portion and the second portion are facilitated. In view of the above, since there is a big difference in thicknesses applicable to the second-layer structure 12 and the second portion 20, the first-layer structure 11 is stacked on the second-layer structure 12 in the first direction, and uniformity of the thicknesses of the first portion 10 and the second portion 20 is realized. In addition to reduction in the light loss, the second-layer structure 12 and the second portion 20 can both have the ideal thicknesses adapted to their machinability and optical effects, so that more efficient coupling-in and coupling-out are realized. In addition, the design is conducive to appearance uniformity and function integration of the segmented hybrid optical waveguide, and the use in conjunction with other optical elements is facilitated accordingly.

As shown in FIGS. 1-10, the second portion 20 includes a plurality of light splitting layers 22 stacked in a direction away from the first portion 10, the light splitting layers 22 are provided with light splitting surfaces 23 arranged obliquely with respect to the second direction, and the light splitting surfaces 23 are configured to couple the light out. The second portion 20 receives the light propagated from the first portion 10, and the light is split once every time it passes through one light splitting surface 23. In other words, part of the light is transmitted and continues to be transmitted backwards, and part of the light is reflected, and then coupled out of the second portion 20 from the coupling-out region 21. With the plurality of light splitting layers 22 designed, the light is reflected and split repeatedly at the second portion 20, so that a light utilization ratio of the segmented hybrid optical waveguide is increased, and brightness and contrast display of the segmented hybrid optical waveguide are improved. Moreover, the light splitting surfaces 23 arranged obliquely relative to the second direction optimizes a light path, reduces light scattering and energy loss, and maintains a good display effect especially in a strong light environment, so that the practicality of outdoor and industrial applications is greatly improved.

In an embodiment mode, the light splitting layers 22 and the second-layer structure 12 are made of a same material. With consistency of the material of the light splitting layers 22 and the second-layer structure 12, the loss of light transmitted between different materials may be avoided, a refractive index difference at an interface may be reduced by virtue of the same material, light reflection and scattering may be reduced, and light transmission efficiency of the segmented hybrid optical waveguide may be improved.

As shown in FIGS. 1-10, reflective indexes of the light splitting surfaces 23 are gradually increased in the direction away from the first portion 10, a minimum reflective index of all the light splitting surfaces 23 satisfies 0.02<Rmin<0.14, and a maximum reflective index of all the light splitting surfaces 23 satisfies 0.13<Rmax<0.35. When the light passes through the second portion 20, the reflective indexes of the light splitting surfaces 23 are increased along with extension of as a light propagation path. When the light enters from the coupling-in region 13, the light energy is gradually reduced as the light is reflected and split by the plurality of light splitting surfaces 23. By gradually increasing the reflective indexes of the light splitting surfaces 23, the loss of the light energy may be compensated, so that the intensity of light coupled out of different positions remains consistent, and consistency of brightness and color of pictures at different reception positions is realized. By limiting Rmin within a certain range, ineffective light splitting caused by a too low reflective index is avoided. Moreover, an influence on uniformity of brightness caused by too sparse distribution of light energy in a subsequent optical path after the light is split excessively because the minimum reflective index is provided to be too high is also avoided. By limiting Rmax within a certain range, proper light splitting and coupling-out inside the segmented hybrid optical waveguide are ensured. Moreover, excessive energy loss and unnecessary internal scattering are avoided, so that optical efficiency and an image quality of the segmented hybrid optical waveguide are improved.

### Example 1

As shown in FIGS. 1-3, a segmented hybrid optical waveguide includes a first portion 10 and a second portion 20; where the first portion 10 includes a first-layer structure 11 and a second-layer structure 12 that are stacked in a first direction, the second-layer structure 12 is provided with a coupling-in region 13 and a turning region 16, and the coupling-in region 13 is configured to couple light in; and the second portion 20 is spliced to the first portion 10 in a second direction, the second direction is provided perpendicular to the first direction, a thickness of the first portion 10 in the first direction equals a thickness of the second portion 20 in the first direction, and the second portion 20 is provided with a coupling-out region 21.

As shown in FIGS. 1-3, a surface on one side, close to the first-layer structure 11, of the second-layer structure 12 is provided with the coupling-in region 13, and a surface of on one side, away from the first-layer structure 11, of the second-layer structure 12 is provided with a plurality of turning grating regions 17, so as to form the turning region 16. After entering the second-layer structure 12 from a coupling-in opening 14, and propagated to the turning grating regions 17 in the turning region 16, the light is limited to be transmitted in the second-layer structure 12. Accordingly, light coupling-in efficiency is ensured, and a light management capacity of the segmented hybrid optical waveguide is improved. In an embodiment mode, the plurality of turning grating regions 17 include a first grating region 171 to an Nth grating region arranged in a direction close to the second portion 20, 3<N<8, and the first grating region 171 to the Nth grating region have an identical grating period and an identical grating line angle; and first-order diffraction efficiency of a second grating region to the Nth grating region is gradually increased, and the first-order diffraction efficiency eff satisfies 0.03<eff<0.77. The plurality of turning grating regions 17 are designed, all the regions have the identical grating period and the identical grating line angle, but the first-order diffraction efficiency of different regions will be gradually increased. Accordingly, energy distribution after diffraction of light at different positions is uniform, so that inconsistency of the brightness and color of the picture is avoided. By controlling eff within a rational range, with the diffraction efficiency gradually changed, the light utilization ratio of the segmented hybrid optical waveguide is increased, a smoother and more natural transition effect is produced in gradually-changed color and brightness display, and visual expressiveness of the segmented hybrid optical waveguide is enhanced.

As shown in FIGS. 1-3, a reflection surface 15 is arranged on the side, away from the second portion 20, of the second-layer structure 12, and the refractive index of the second-layer structure 12 is greater than that of the first-layer structure 11, so that the light is incident from a surface on one side, away from the second-layer structure 12, of the first-layer structure 11, reflected by the reflection surface 15 through the coupling-in opening 14 of the coupling-in region 13, and then transmitted in the second-layer structure 12 in a total reflection mode; and an included angle θ₁ between the reflection surface 15 and a surface on one side, in the first direction, of the second-layer structure 12 satisfies 25°<θ₁<35°.

In the example, after the light is incident into the coupling-in opening 14 from the surface on the side, away from the second-layer structure 12, of the first-layer structure 11, the reflection surface 15 reflects the light coupled in from the coupling-in opening 14 to an interior of the second-layer structure 12. Setting the refractive index of the second-layer structure 12 to be higher than that of the first-layer structure 11 enables total internal reflection of the light in the second-layer structure 12. In this way, the light may be transmitted in the second-layer structure 12 without leaking into the first-layer structure 11 until the light enters the second portion 20. If θ1 is too small, the light reflected by the reflection surface 15 can hardly be totally reflected by the surface of the second-layer structure 12, resulting in that the light cannot be effectively transmitted to the second portion 20. If θ₁ is too large, the room reserved for the coupling-in region 13 is too small, the light cannot be coupled in the second-layer structure 12 conveniently, affecting the coupling-in efficiency of the segmented hybrid optical waveguide. By limiting the included angle θ₁ within a rational range, effective light coupling-in and transmission may be realized, the light loss in a transmission process may be reduced, stability and clarity of image information in a long-distance transmission process may be ensured, and more natural and smoother visual experience may be offered.

As shown in FIGS. 1-3, the second portion 20 includes a plurality of light splitting layers 22 stacked in a direction away from the first portion 10, and the light splitting layers 22 are provided with light splitting surfaces 23 arranged obliquely with respect to the second direction; and an inclination angle β of the light splitting surfaces 23 equals the included angle θ₁, and a thickness T of the second portion 20, the included angle θ₁, and a distance Δd between two adjacent light splitting surfaces 23 satisfy 0.90*T/tan(θ₁)<Δd<1.10*T/tan(θ₁). The second portion 20 is composed of the plurality of light splitting layers 22, and the light splitting layers 22 are stacked in the direction away from the first portion, so that the light is coupled out at different positions. In addition, by limiting a range of the distance Δd between adjacent light splitting surfaces 23, light propagation efficiency and effects light between the light splitting layers 22 are ensured. The precise distance can ensure uniformity of light energy after the light is coupled out of the light splitting surfaces 23, improve uniformity of image display at different reception positions, effectively avoid hot spots and dark spots in the display, and offer a more delicate and realistic display effect. By controlling a certain proportional relation among Δd, T, and θ₁, the light transmitted from the first portion 10 to the second portion 20 is not turned, and the propagated picture is complete without deflections.

In an embodiment mode, a thickness t_{base} of the second-layer structure 12 satisfies 0.2 mm<t_{base}<5.0 mm. When propagated in the second-layer structure 12, the light needs to make contact with the grating, so as to be diffracted. If the second-layer structure 12 is too thick, a total reflection step of the light before reaching the grating will be increased, and a difference in numbers of contact with the grating of the light having different wavelengths will also be increased, resulting in pupil separation, and in other words, the light in different colors cannot be focused at a same position, affecting the consistency of color. If the second-layer structure 12 is too thin, the physical size demands or process machining constraints of the grating can hardly be satisfied. By limiting t_{base} within a rational range, both machinability and a desirable optical effect of the second-layer structure 12 are realized, and the difference in numbers of contact with the grating of the light having different wavelengths is reduced, so that the consistency of color of emergent light is ensured.

In an embodiment mode, the thickness T of the second portion 20 satisfies 0.4 mm<T<10 mm. If T is too small, more light splitting layers 22 need to be stacked for a desirable light splitting effect, leading to a long machining process flow and a low yield. If T is too large, reduction in light transmission efficiency or distortion of the optical path may be caused. By limiting T within a rational range, control of a pupil separation phenomenon, improvement of coupling-out efficiency, and simplification of a production process are comprehensively considered to improve the yield, and the machinability and optical effect of the second portion 20 may be balanced.

In an embodiment mode, a thickness t_{glass} of the first-layer structure 11 satisfies 0.2 mm<t_{glass}<5.0 mm. By limiting t_{glass} within a rational range matching the thickness of the second-layer structure 12, a total thickness of the first-layer structure 11 and the second-layer structure 12 that are stacked equals the thickness of the second portion 20. Accordingly, machinability of each structure may be balanced, and the working thicknesses applicable to the first portion 10 and the second portion 20 may be retained.

In an embodiment mode, a refractive index n_{glass} of the first-layer structure 11 satisfies 1.5<n_{glass}<2.2. By limiting the n_{glass} within a rational range, and controlling propagation characteristics of the light in the segmented hybrid optical waveguide, including a total reflection condition, a diffraction angle, and a reflection effect of the light splitting layers 22, a critical angle of total reflection may be reduced, the light is more likely to be propagated in the waveguide, and diffraction efficiency of the grating may be improved.

In an embodiment mode, FIG. 1 depicts the segmented hybrid optical waveguide according to Example 1. The first-layer structure 11 is bonded to the second-layer structure 12 through a bonding glue. In an embodiment mode, θ₁=29°, T=1.5 mm, Δd=2.711 mm, t_{base}=0.75 mm, t_{glass}=0.75 mm, n_{base}=1.84, and n_{glass}=1.25. As shown in FIG. 10, an angular component θ_{H} in an H direction before the light enters the segmented hybrid optical waveguide is 13.15°, eight light splitting layers 22 are provided, and refractive indexes Ri of an ith light splitting layer in the direction away from the first portion 10 are R₁=R₂=0.087, R₃=R₄=0.11, R₅=R₆=0.16, and R₇=R₈=0.2.

As shown in FIG. 2, the first-layer structure 11 is in bonding connection to the second-layer structure 12 by means of a bonding glue; and the refractive index n_{base} of the second-layer structure 12, a refractive index n_{glue} of the bonding glue, and a minimum incident angle αₘᵢₙ of the light in a direction from the second-layer structure 12 to the first-layer structure 11 satisfy n_{base}−n_{glue}≥n_{base}*(1−sin(αₘᵢₙ)). With the bonding glue having the appropriate refractive index, light reflection at the interface may be effectively reduced, and overall performance of the hybrid optical waveguide may be improved especially in a long-term use scene, and more comfortable and lasting wearing experience may be offered.

In an embodiment mode, αₘᵢₙ satisfies

$${α}_{min} = 2 * {θ}_{1} - arcsin ( sin ( {θ}_{H} ) / {n}_{base} ) . \qquad formula ( 1 )$$

On the basis of the formula (1), efficient light transmission may be realized, the light loss in a transmission process may be reduced, stability and clarity of the light in a long-distance transmission process may be ensured, and more natural and smoother visual experience may be offered.

In an embodiment mode, the segmented hybrid optical waveguide according to the example may be used for augmented reality (AR) glasses.

### Example 2

As shown in FIGS. 4-6, Example 2 of the disclosure is described, and is different from Example 1 in a coupling-in method of light and a bonding method of a first-layer structure 11 and a second-layer structure 12.

As shown in FIGS. 4-6, one side, away from a second portion 20, of the second-layer structure 12 is provided with a coupling-in region 13, and a surface on one side, away from the first-layer structure 11, of the second-layer structure 12 is provided with a plurality of turning grating regions 17, so as to form a turning region 16. The second portion 20 includes a plurality of light splitting layers 22 stacked in a direction away from a first portion 10, and the light splitting layers 22 are provided with light splitting surfaces 23 arranged obliquely with respect to a second direction.

In an embodiment mode, an included angle θ₂ between a surface where a coupling-in opening 14 of the coupling-in region 13 is located, and a surface on one side, in a first direction, of the second-layer structure 12 satisfies 50°<θ₂<70°. By controlling θ₂ within a rational range, an initial propagation direction of the coupled-in light is directly affected. Accordingly, when entering the second-layer structure 12, the light can form a preset incident angle with the turning region 16, ensuring that the light has a sufficient incident angle with the turning region 16 in a subsequent propagation process, so as to implement total internal reflection. Thus, premature light leakage is avoided, and energy loss caused by a light coupling-in failure on the basis of a too large angle or caused by a too long light propagation distance in the second-layer structure 12 on the basis of a too small angle is also avoided.

In an embodiment mode, an inclination angle β of the light splitting surfaces 23 is half of the included angle θ₂, and a thickness T of the second portion 20, the included angle θ₂, and a distance Δd between two adjacent light splitting surfaces 23 satisfy: 0.90*T/tan(θ₂)<Δd<1.10*T/tan(θ₂). The inclination angle β is designed to be half of the included angle θ₂. Accordingly, it is ensured that a light propagation path in the first portion 10 matches a path in the second portion 20, and light deflection or scattering caused by an abrupt change in optical path is avoided. If the distance between adjacent light splitting layers 22 is too small, in order to satisfy the demand of coupling out the light to a reception end, the light splitting layers 22 are required to be arranged very densely, and in other words, a number of stacking the light splitting layers 22 is required to be increased, which is inconducive to control over the production yield and cost. If the distance between adjacent light splitting layers 22 is too large, the light needs to be reflected repeatedly, so as to be coupled out. In this way, light loss inside the segmented hybrid optical waveguide is increased, leading to degradation in image quality. By controlling 0.90*T/tan(θ₂)<Δd<1.10*T/tan(θ₂), a rational distance between the light splitting layers 22 is ensured. Moreover, a total number of the light splitting layers 22 is reduced, so that the complexity and cost of production may be greatly reduced, light scattering between the light splitting layers 22 may be reduced, and the clarity of display may be improved.

In an embodiment mode, θ₂=60°, T=1.5 mm, Δd=2.8 mm, t_{base}=0.8 mm, t_{glass}=0.7 mm, n_{base}=2.0, n_{glass}=1.51, and θ_{H}=13.15°. Nine light splitting layers 22 are provided, and refractive indexes Ri of an ith light splitting layer in the direction away from the first portion 10 are R₁=R₂=R₃=0.05, R₄=R₅=0.73, R₆=R₇=0.116, and R₈=R₉=0.2.

In an embodiment mode, αₘᵢₙ satisfies

$${α}_{min} = {θ}_{2} - arcsin ( sin ( {θ}_{H} ) / {n}_{base} ) . \qquad formula ( 2 )$$

On the basis of the formula (2), the light enters the second-layer structure 12 directly from the outside. In this way, higher coupling-in efficiency may be realized generally, and light scattering and energy loss that may result from reflection by mean of the reflection surface may be avoided. The high efficiency of refractive coupling-in is crucial for enhancing display brightness and ensuring high clarity.

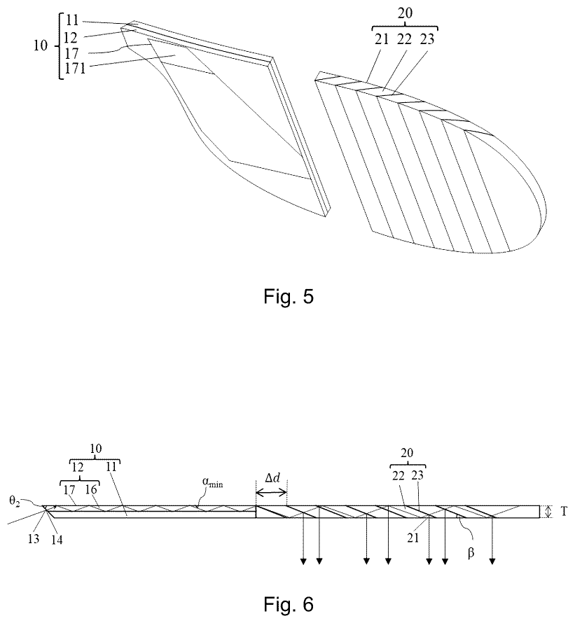

As shown in FIG. 5, the first-layer structure 11 is in molecular bonding connection to the second-layer structure 12; and a refractive index n_{base} of the second-layer structure 12, a refractive index n_{glass} of the first-layer structure 11, and a minimum incident angle αₘᵢₙ of the light in a direction from the second-layer structure 12 to the first-layer structure 11 satisfy n_{base}−n_{glass}≥n_{base}*(1−sin(αₘᵢₙ)). Through the molecular bonding connection, structural strength of the segmented hybrid optical waveguide is ensured, and a flatter bonding surface is provided between the first-layer structure 11 and the second-layer structure 12. Accordingly, light transmission efficiency between different materials is optimized, and excessive light loss in the transmission process is avoided. By controlling a relation of the refractive indexes, it is ensured that the light may be effectively confined in the second-layer structure 12 and can undergo total internal reflection when propagated from the second-layer structure 12 to the first-layer structure 11, so that the optical path is turned, and a pupil is enlarged.

### Example 3

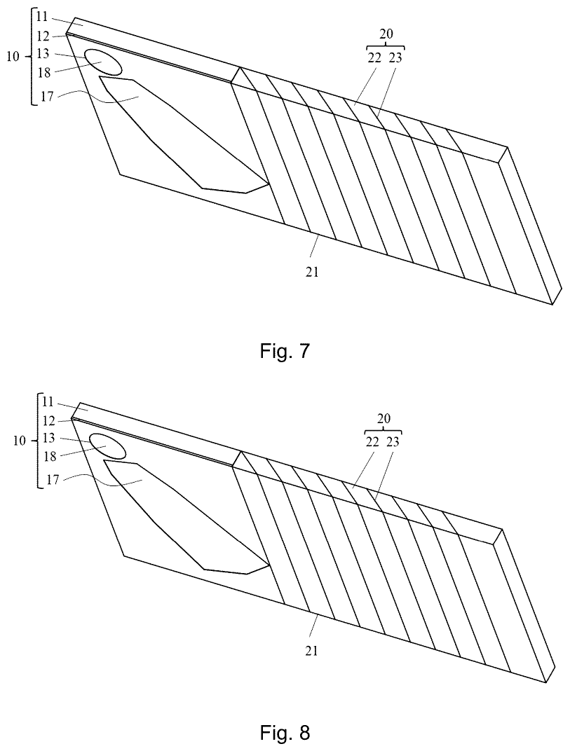

As shown in FIGS. 7-9, Example 3 of the disclosure is described, and is different from Example 1 in an arrangement of a coupling-in region 13 of light, and a bonding method of a first-layer structure 11 and a second-layer structure 12.

In an embodiment mode, a surface on one side, away from the first-layer structure 11, of the second-layer structure 12 is provided with the coupling-in region 13, and a plurality of turning grating regions 17 to form a turning region 16, and a coupling-in opening 14 of the coupling-in region 13 is provided with a coupling-in grating 18, so that the light is coupled in the second-layer structure 12 through the coupling-in grating 18. The coupling-in region 13 is located on the surface, away from the first-layer structure 11, of the second-layer structure 12, and the light can directly enter the second-layer structure 12 through the coupling-in grating 18 of the coupling-in opening 14. The coupling-in grating 18 can ensure efficient light coupling-in, reduce light scattering during coupling-in, and improve energy efficiency and a display quality of the segmented hybrid optical waveguide. During subsequent light propagation and processing in the turning region 16, light having different wavelengths will have different diffraction angles due to different grating periods and different grating line angles when making contact with the turning grating regions 17. Under the action of a diffraction effect of the turning grating regions 17, light splitting and direction turning are realized.

It should be noted that the coupling-in grating 18 may be a diffraction grating in a form of a blazed grating, a straight-tooth grating, an oblique-tooth grating, etc., so as to match a large projection opening of an optical projection machine. The coupling-in grating is selected depending on coupling-in efficiency and an optical path that are demanded.

In an embodiment mode, β=35°, T=10 mm, Δd=14.2 mm, t_{base}=1 mm, t_{glass}=9 mm, n_{base}=2.0, and n_{glass}=1.51. Nine light splitting layers 22 are provided, and refractive indexes Ri of an ith light splitting layer in the direction away from the first portion 10 are R₁=R₂=R₃=0.05, R₄=R₅=0.73, R₆=R₇=0.116, and R₈=R₉=0.2.

In an embodiment mode, the segmented hybrid optical waveguide according to the example may be used for a vehicle-mounted head-up display (HUD), etc. The thickness t_{glass} of the first-layer structure 11 is provided to 9 mm, so as to satisfy application demands of the vehicle-mounted HUD, etc. With large t_{glass}, sufficient structural support may be offered, light scattering caused by an insufficient thickness may be reduced, and stability and a quality of light coupling-out may be improved.

Apparently, the examples described above are merely some examples rather than all examples of the disclosure. Based on the examples of the disclosure, all other examples derived by those of ordinary skill in the art without creative efforts should fall within the scope of protection of the disclosure.

It should be noted that the terms used herein are merely used to describe particular embodiments, and are not intended to limit illustrative embodiments according to the disclosure. As used herein, the singular form is also intended to include the plural form, unless clearly indicated in the context otherwise. In addition, it should also be understood that when used in the description, the terms “encompass” and/or “comprise” and “include” specify the presence of features, steps, operations, devices, assemblies, and/or their combinations.

It should be noted that the terms “first”, “second”, etc. in the description, the claims, and the above accompanying drawings of the disclosure are used to distinguish between similar objects, instead of necessarily describing a particular sequence or a successive order. It should be understood that data used in this way may be interchanged where appropriate, so that the embodiments of the disclosure described herein may be implemented in other sequences than those illustrated or described herein.

What are described above are merely preferred examples of the disclosure, and are not intended to limit the disclosure. Those skilled in the art can make various modifications and variations to the disclosure. Any modifications, equivalent replacements, improvements, etc. made within the spirit and principles of the disclosure should fall within the scope of protection of the disclosure.

What is claimed is:

1. A segmented hybrid optical waveguide, comprising:
a first portion, wherein the first portion comprises a first-layer structure and a second-layer structure that are stacked in a first direction, the second-layer structure is provided with a coupling-in region and a turning region, and the coupling-in region is configured to couple light in; and
a second portion, wherein the second portion is spliced to the first portion in a second direction, the second direction is provided perpendicular to the first direction, a thickness of the first portion in the first direction equals a thickness of the second portion in the first direction, and the second portion is provided with a coupling-out region.

2. The segmented hybrid optical waveguide according to claim 1, wherein the second portion comprises a plurality of light splitting layers stacked in a direction away from the first portion, the light splitting layers are provided with light splitting surfaces arranged obliquely with respect to the second direction, and the light splitting surfaces are configured to couple the light out.

3. The segmented hybrid optical waveguide according to claim 1, wherein
the first-layer structure is in molecular bonding connection to the second-layer structure; and a refractive index n_{base} of the second-layer structure, a refractive index n_{glass} of the first-layer structure, and a minimum incident angle αₘᵢₙ of the light in a direction from the second-layer structure to the first-layer structure satisfy n_{base}−n_{glass}≥n_{base}*(1−sin(αₘᵢₙ)); and/or,
the first-layer structure is in bonding connection to the second-layer structure by means of a bonding glue; and a refractive index n_{base} of the second-layer structure, a refractive index n_{glue} of the bonding glue, and a minimum incident angle αₘᵢₙ of the light in a direction from the second-layer structure to the first-layer structure satisfy n_{base}−n_{glue}≥n_{base}*(1−sin(αₘᵢₙ)).

4. The segmented hybrid optical waveguide according to claim 1, wherein a surface on one side, close to the first-layer structure, of the second-layer structure is provided with the coupling-in region, and a surface on one side, away from the first-layer structure, of the second-layer structure is provided with a plurality of turning grating regions, so as to form the turning region.

5. The segmented hybrid optical waveguide according to claim 4, wherein a reflection surface is arranged on one side, away from the second portion, of the second-layer structure, and a refractive index of the second-layer structure is greater than that of the first-layer structure, so that the light is incident from a surface on one side, away from the second-layer structure, of the first-layer structure, reflected by the reflection surface through a coupling-in opening of the coupling-in region, and then transmitted in the second-layer structure in a total reflection mode; and an included angle θ1 between the reflection surface and a surface on one side, in the first direction, of the second-layer structure satisfies 25°<θ1<35°.

6. The segmented hybrid optical waveguide according to claim 5, wherein the second portion comprises a plurality of light splitting layers stacked in a direction away from the first portion, and the light splitting layers are provided with light splitting surfaces arranged obliquely with respect to the second direction; and an inclination angle β of the light splitting surfaces equals the included angle θ₁, and a thickness T of the second portion, the included angle θ₁, and a distance Δd between two adjacent light splitting surfaces satisfy 0.90*T/tan(θ₁)<Δd<1.10*T/tan(θ₁).

7. The segmented hybrid optical waveguide according to claim 1, wherein one side, away from the second portion, of the second-layer structure is provided with the coupling-in region, and an included angle θ₂ between a surface where a coupling-in opening of the coupling-in region is located, and a surface on one side, in the first direction, of the second-layer structure satisfies 50°<θ₂<70°.

8. The segmented hybrid optical waveguide according to claim 7, wherein a surface on one side, away from the first-layer structure, of the second-layer structure is provided with a plurality of turning grating regions, so as to form the turning region.

9. The segmented hybrid optical waveguide according to claim 7, wherein the second portion comprises a plurality of light splitting layers stacked in a direction away from the first portion, and the light splitting layers are provided with light splitting surfaces arranged obliquely with respect to the second direction; and an inclination angle β of the light splitting surfaces is half of the included angle θ₂, and a thickness T of the second portion, the included angle θ₂, and a distance Δd between two adjacent light splitting surfaces satisfy 0.90*T/tan(θ₂)<Δd<1.10*T/tan(θ₂).

10. The segmented hybrid optical waveguide according to claim 1, wherein a surface on one side, away from the first-layer structure, of the second-layer structure is provided with the coupling-in region, and a plurality of turning grating regions to form the turning region; and a coupling-in opening of the coupling-in region is provided with a coupling-in grating, so that the light is coupled in the second-layer structure through the coupling-in grating.

11. The segmented hybrid optical waveguide according to claim 4, wherein the plurality of turning grating regions comprise a first grating region to an Nth grating region arranged in a direction close to the second portion, 3<N<8, and the first grating region to the Nth grating region have an identical grating period and an identical grating line angle; and first-order diffraction efficiency of a second grating region to the Nth grating region is gradually increased, and the first-order diffraction efficiency eff satisfies 0.03<eff<0.77.

12. The segmented hybrid optical waveguide according to claim 2, wherein the light splitting layers and the second-layer structure are made of a same material.

13. The segmented hybrid optical waveguide according to claim 2, wherein reflective indexes of the light splitting surfaces are gradually increased in the direction away from the first portion, a minimum reflective index of all the light splitting surfaces satisfies 0.02<Rmin<0.14, and a maximum reflective index of all the light splitting surfaces satisfies 0.13<Rmax<0.35.

14. The segmented hybrid optical waveguide according to claim 1, wherein
a thickness t_{glass} of the first-layer structure satisfies 0.2 mm<t_{glass}<5.0 mm.

15. The segmented hybrid optical waveguide according to claim 1, wherein
a thickness t_{base} of the second-layer structure satisfies 0.2 mm<t_{base}<5.0 mm.

16. The segmented hybrid optical waveguide according to claim 1, wherein
a thickness T of the second portion satisfies 0.4 mm<T<10 mm.

17. The segmented hybrid optical waveguide according to claim 1, wherein
a refractive index n_{glass} of the first-layer structure satisfies 1.5<n_{glass}<2.2.

18. The segmented hybrid optical waveguide according to claim 8, wherein the plurality of turning grating regions comprise a first grating region to an Nth grating region arranged in a direction close to the second portion, 3<N<8, and the first grating region to the Nth grating region have an identical grating period and an identical grating line angle; and first-order diffraction efficiency of a second grating region to the Nth grating region is gradually increased, and the first-order diffraction efficiency eff satisfies 0.03<eff<0.77.

19. The segmented hybrid optical waveguide according to claim 6, wherein the light splitting layers and the second-layer structure are made of a same material.

20. The segmented hybrid optical waveguide according to claim 6, wherein reflective indexes of the light splitting surfaces are gradually increased in the direction away from the first portion, a minimum reflective index of all the light splitting surfaces satisfies 0.02<Rmin<0.14, and a maximum reflective index of all the light splitting surfaces satisfies 0.13<Rmax<0.35.
